(19) United States
(12) Patent Application Publication
(10) Pub. No.: US 2014/0297578 A1
(43) Pub. Date: Oct. 2, 2014

(54) PROCESSING A TECHNICAL SYSTEM

(71) Applicants: Mikhail Roshchin, Feldkirchen (DE); Holger Stender, Nurnberg (DE); Stuart Watson, Newark (GB)

(72) Inventors: Mikhail Roshchin, Feldkirchen (DE); Holger Stender, Nurnberg (DE); Stuart Watson, Newark (GB)

(73) Assignee: SIEMENS AKTIENGESELLSCHAFT, Munich (DE)

(21) Appl. No.: 14/353,056

(22) PCT Filed: Oct. 28, 2011
(86) PCT No.: PCT/EP2011/069014

§ 371 Date: Jun. 7, 2014

(51) Int. Cl. G06N 5/04

(52) U.S. Cl. CPC G06N 5/04
USPC 706/46

(57) ABSTRACT

A method for processing a technical system is provided to predict a technical system's state and/or to provide a diagnosis of the technical system or at least one of its components. The prediction is determined based on a model-based complex event processing (CEP) approach using declarative models. This facilitates considering complex information sources as input data and allows providing a diagnosis based on diagnostic models, wherein the models can be interpreted and/or changed even by users who are not programmers. In addition, time and/or temporal relations can be modeled and considered and an open world assumption can be incorporated to allow more valuable assessments of diagnoses. The invention is applicable for all kinds of technical systems, e.g., industry and automation systems comprising in particular rotating devices and/or generators.

### CROSS REFERENCE TO RELATED APPLICATIONS

This application is the US National Stage of International Application No. PCT/EP2011/069014 filed Oct. 28, 2011, incorporated by reference herein in its entirety.

### FIELD OF INVENTION

The invention relates to a method and to a device for processing a technical system, in particular comprising a prediction and/or diagnosis of the technical system or a component or portion thereof.

### BACKGROUND OF INVENTION

Technical systems comprise several components, e.g., rotating equipment, generators, etc., that are subject to diagnosis, supervision and maintenance.

Existing solutions for, e.g., rotating equipment diagnoses either belong to the class of expert systems or are specifically programmed for particular solutions with a rather narrow problem space and with a limited range of supported use cases and scenarios.

Said expert systems typically utilize classical deduction schemes (i.e. deductive reasoning mechanisms) with all its limitations, e.g., without any possibility to appropriately consider temporal, incomplete or uncertain information.

The solution that is specifically programmed for a particular scenario is of limited flexibility and cannot cope with complex diagnostic scenarios, in particular when the structure of a technical systems changes or is extended.

It is also a problem that in particular any diagnosis of, e.g., rotating equipment such as gas and steam turbines involves large amounts of incomplete or uncertain information, e.g.,
missing sensor information;
wrong measurements;
incorrect diagnostic models.

Complex event processing (CEP) (see e.g., http://en.wikipedia.org/wiki/Complex_event_processing) consists of processing many events happening across all the layers of an organization, identifying the most meaningful events within the event cloud, analyzing their impact, and taking subsequent action in real time. Complex event processing refers to process states, the changes of state exceeding a defined threshold of level, time, or value increment or just of a count as the event. It requires the respective event monitoring, event reporting, event recording and event filtering. An event may be observed as a change of state with any physical or logical or otherwise discriminated condition of and in a technical or economical system, each state information with an attached time stamp defining the order of occurrence and a topology mark defining the location of occurrence.

The use of this known CEP is not suitable for diagnostic purposes, in particular because its SQL-like syntax is not appropriate for diagnostic models at all. SQL is a language that suits well for databases to access data in various ways, but it is not suitable for further analysis, which is a prerequisite for any diagnosis.

CEP techniques does neither work well for failure identification and fault isolation in rotating equipment diagnosis, because they cannot cope with incomplete and uncertain information: If values that are important for diagnosis are missing, the fault or failure may not be detected at all. Also, if a set of values except for a single value would confirm a certain failure, this failure may also not be detected by known CEP techniques.

### SUMMARY OF INVENTION

An objective is thus to provide an improved approach for prediction, in particular diagnosis and/or fault detection of a technical system, e.g., a rotating device, a generator, a supply chain, a manufacturing system, a delivery system or the like.

This problem is solved according to the features of the independent claims. Further embodiments result from the depending claims.

In order to overcome this problem, a method is provided for processing a technical system, wherein a prediction of the technical system is determined based on a model-based complex event processing approach using declarative models.

The model-based complex event processing (CEP) approach uses declarative models instead of SQL-like syntax of prior art CEP approaches. Declarative models utilize declarative programming techniques which correspond to a programming paradigm that expresses the logic of a computation without describing its control flow (see also http://en.wikipedia.org/wiki/Declarative_programming). Many languages applying this style attempt to minimize or eliminate side effects by describing what the program should accomplish, rather than describing how to go about accomplishing it. This is in contrast with imperative programming, which requires an explicitly provided algorithm. Declarative programming often considers programs as theories of a formal logic, and computations as deductions in that logic space. Common declarative languages include those of regular expressions, logic programming, and functional programming.

This approach facilitates considering complex information sources as input data and allows providing a diagnosis based on diagnostic models, wherein said models can be interpreted and/or changed even by users who are not programmers. In addition, time and/or temporal relations can be modeled and considered and an open world assumption can be incorporated to allow more valuable assessments of diagnoses.

The prediction is conducted based on various types of information (also referred to as input data) supplied by the technical system and/or any other knowledge base, e.g., sensor signals, measurement data, engineering data, events, logs, reports, etc.

It is noted that said prediction may refer to a part of the technical system, e.g., a component or several components thereof. Said prediction may in particular comprise predicting a status or state of the technical system or a portion thereof. The prediction may in particular comprise an evaluation of input data as a diagnosis of the technical system or a portion (or at least one component) thereof. The prediction may in particular relate to any actual or future state of the technical system.

In an embodiment, the technical system comprises a rotating equipment and/or a generator.

The technical system may comprise a turbine, in particular a gas turbine and/or a steam turbine.

In another embodiment, based on said prediction, a diagnosis of the technical system or a portion thereof is determined.

In a further embodiment, based on said prediction and/or based on the diagnosis a predetermined action is conducted.

In a next embodiment, the model-based complex event processing approach is based on an open world assumption.

It is also an embodiment that the open world assumption is realized via deductive reasoning on description logics.

Hence, it is an option to use a hybrid solution combining the model-based CEP approach with deductive reasoning on description logics, which facilitates the open world assumption principle.

For this hybrid solution to be realized, the diagnostic tasks could be split into failure detection and fault isolation: The model-based CEP can be used for failure detection purposes and the deductive reasoning on description logics can be used for fault isolation purposes.

Pursuant to another embodiment, based on the deductive reasoning on description logics, a tentative prediction or diagnosis is provided based on incomplete, missing or wrong input data.

According to an embodiment, an explanation for the tentative prediction or diagnosis is generated.

For instance, if some values important for a particular diagnosis are missing or if most values from measurements (except for, e.g., one single value) confirm a certain definition of a diagnosis, the diagnosis can be made and marked as “tentative”, also providing an explanation why this diagnosis is marked tentative.

According to another embodiment, the model-based complex event processing approach comprises definitions of events, complex events and a correlation mechanism for information sources.

The “event” enables abstraction for various types of input information defined in the diagnostic model. The concept of “complex event” is a native modeling mechanism for correlating various information sources and objectives in the definition of any concrete diagnostic situation.

In yet another embodiment, the model-based complex event processing approach comprises processing data streams in parallel.

The processing allows working with data in a highly efficient manner in, e.g., real time with various streams of information (data) in parallel.

According to a next embodiment, the model-based complex event processing approach is utilized by an optimization algorithm.

One example of such an optimization algorithm is the RETE algorithm (see, e.g., http://en.wikipedia.org/wiki/Rete_algorithm).

Pursuant to yet an embodiment, the model-based complex event processing approach comprises temporal reasoning.

This allows interworking with discrete time and/or temporal operators.

According to a further embodiment, the model-based complex event processing approach comprises induction or abduction mechanisms.

The problem stated above is also solved by a device for processing a technical system comprising a processing unit that is arranged for determining a prediction of the technical system based on a model-based complex event processing approach using declarative models.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

According to an embodiment, the technical system may be a rotating device or a generator, in particular a gas turbine.

Said processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

Furthermore, the problem stated above is solved by a system comprising at least one device as described herein.

### BRIEF DESCRIPTION OF THE DRAWINGS

The aforementioned characteristics, features and advantages of the invention as well as the way they are achieved will be further illustrated in connection with the following examples and considerations as discussed in view of the figures.

FIG. 1 shows an exemplary diagram visualizing the approach of using the model-based CEP approach for gas turbine diagnosis purposes;

FIG. 2 shows an exemplary diagnostic platform comprising the model-based CEP component in combination with the data base shown in and explained with regard to FIG. 1 as a so-called core engine;

FIG. 3 shows an exemplary diagram visualizing the approach of using the (model-based) CEP approach in combination with the OWA for gas turbine diagnosis purposes.

### DETAILED DESCRIPTION OF INVENTION

A specific (in particular modified) complex event processing (CEP) approach is suggested, referred to herein as model-based CEP, which can be used as a core engine for any kind of complex diagnostic platform, using declarative models (instead of the SQL-like syntax of known CEP).

This approach enables in particular the following effects or advantages:

(1) The known CEP approach is enhanced by providing definitions of “events” and “complex events”, as well as native correlation mechanisms for heterogeneous information sources:
The “event” enables abstraction for various types of input information defined in the diagnostic model.
The concept of “complex event” is a native modeling mechanism for correlating various information sources and objectives in the definition of any concrete diagnostic situation.
The processing allows working with data in a highly efficient manner in, e.g., real time with various streams of information or data in parallel.

(2) The model-based CEP provides an intention to use declarative models instead of SQL-like syntax. This approach in particular allows at least one of the following:
providing declarative modeling instead of hard-coding; hence, a user who is not a programmer, e.g., a service, diagnostic or maintenance engineer, can define or change the diagnostic model.
applying additional optimization algorithms for processing the diagnostic models (e.g., RETE algorithm (see, e.g., http://en.wikipedia.org/wiki/Rete_algorithm), automated consistency checking).
a native support for most features of temporal reasoning (i.e. working with discrete time and temporal operators).
applying additional (native) automated reasoning algorithms, such as induction and/or abduction.
native support for any administration of models, i.e. visualization, classification, serialization, etc.

The declarative model corresponds to a modeling and programming paradigm that exploits the logic of a required analysis without describing its control flow (i.e. hard-coded algorithms). Thus, any user who is not familiar with programming techniques may be able to model diagnostic algorithms.

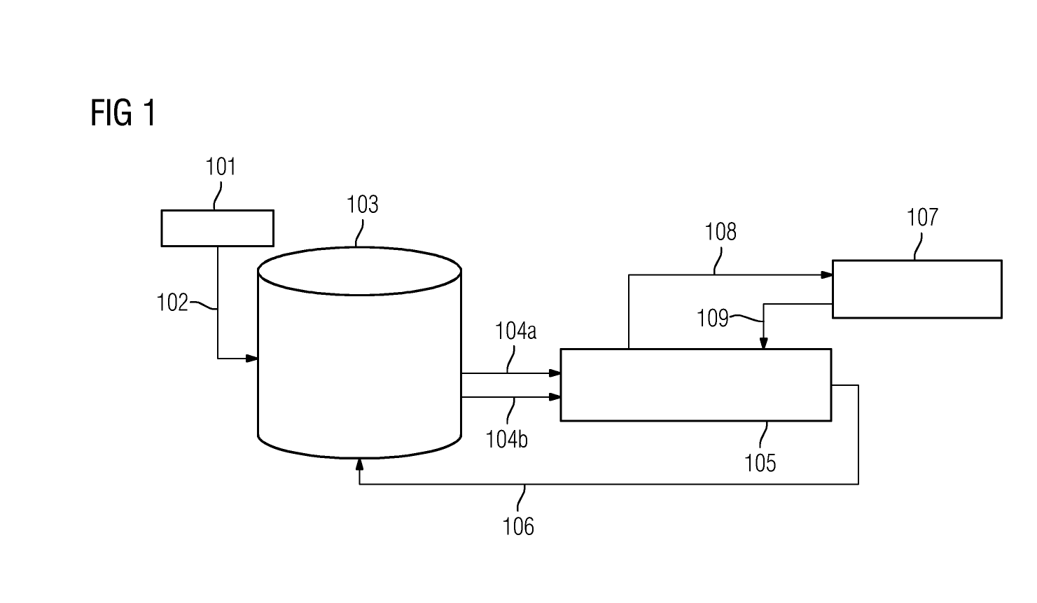

FIG. 1 shows an exemplary diagram visualizing the approach of using the model-based CEP approach for gas turbine diagnosis purposes.

A gas turbine 101 provides signals 102 to a data base 103. The signals 102 may comprise messages, reports, vibration analyses, etc. The data base 103 comprises various information, e.g. sensor signals, engineering information, events, logs, operational reports and the like.

Streams of information 104a and 104b can be fed in parallel to a model-based CEP component 105, which determines results 106, e.g., diagnoses, and feeds them back to the data base 103. Also, said results 106 can be used to conduct a predefined action, e.g., stop or slow down the gas turbine 101.

It is also an option that results and/or additional information 108 is/are provided to an input and/or output device 107, e.g., a display, a loudspeaker, etc. The input/output device 107 can be used by a diagnostic engineer to evaluate the information 108 provided by the component 105 and/or the diagnostic models may be adjusted (see arrow 109).

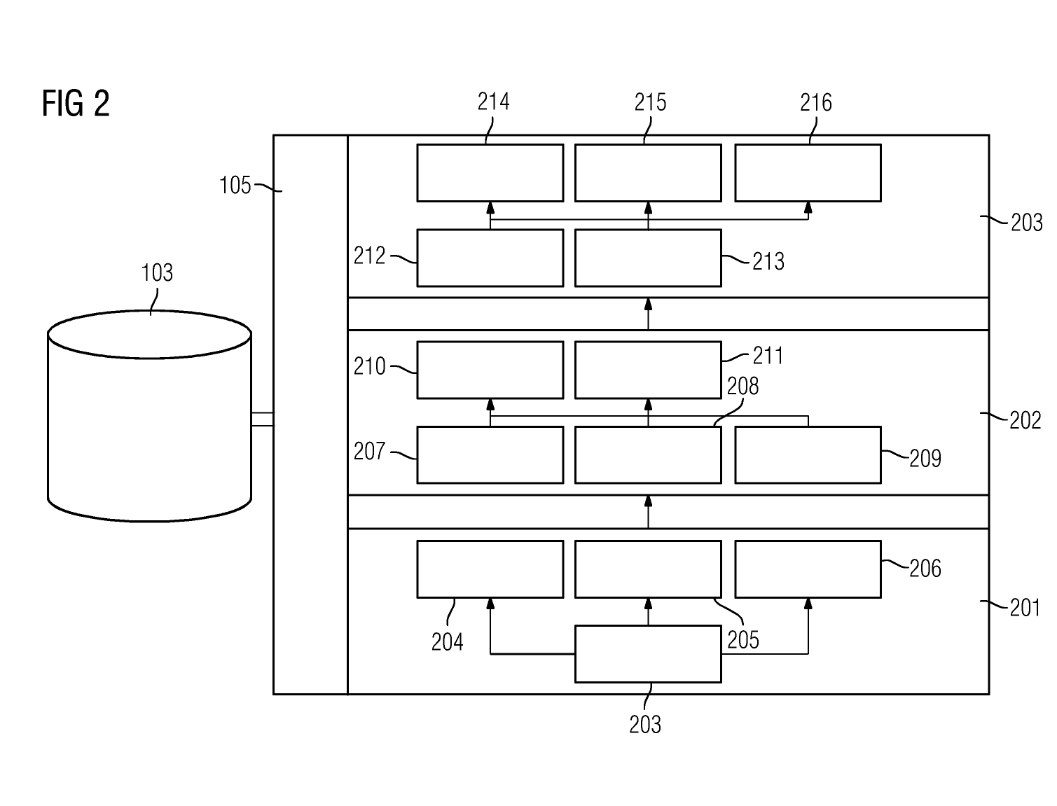

FIG. 2 shows an exemplary diagnostic platform comprising the model-based CEP component 105 in combination with the data base 103 shown in and explained with regard to FIG. 1 as a so-called core engine.

This core engine supports several layers, in particular a data gathering layer 201, a data interpretation layer 202 and a prediction/analysis layer 203.

The data gathering layer 201 comprises a data and information modeling unit 203 that is used by a data correlation unit 204, an information integration unit 205 and an embedded fault detection unit 206. The data gathering layer 201 provides services for the data interpretation layer 202.

The data interpretation layer 202 comprises a complex event analysis unit 207, a symptom-based diagnosis unit 208 and a diagnostic rule management unit 209, which are used by a trend analysis unit 210 and a tentative diagnosis unit 210. The data interpretation layer 202 provides services for the prediction/analysis layer 203.

The prediction/analysis layer 203 comprises a predictive diagnosis unit 212 and an interactive diagnosis unit 213, which can be used by a maintenance optimization unit 214, a legacy system extension unit 215 and a rule-based administration unit 216.

It is noted that the units shown in FIG. 2 are merely an exemplary arrangement. Only some of them may be implemented, based on the requirement of a particular scenario or use-case. The units can be implemented in a combined physical entity or in separate devices. It is also an option that a single unit is implemented in a distributed fashion among several physical entities.

It is also an option to use a hybrid solution combining the model-based CEP approach with deductive reasoning on description logics, which facilitates the open world assumption principle.

In formal logic, the open world assumption (OWA) is the assumption that the truth-value of a statement is independent of whether or not it is known by any single observer or agent to be true. It is the opposite of the closed world assumption, which holds that any statement that is not known to be true is false. The open world assumption (OWA) is used in knowledge representation to codify the informal notion that in general no single agent or observer has complete knowledge, and therefore cannot make the closed world assumption. The OWA limits the kinds of inference and deductions an agent can make to those that follow from statements that are known to the agent to be true. In contrast, the closed world assumption allows an agent to infer, from its lack of knowledge of a statement being true, anything that follows from that statement being false. For further reference see, e.g., http://en.wikipedia.org/wiki/Open_world_assumption.

For this hybrid solution to be realized, the diagnostic tasks could be split into failure detection and fault isolation: The model-based CEP can be used for failure detection purposes and the deductive reasoning on description logics can be used for fault isolation purposes, wherein the model-based CEP supplies input data and the output of the deductive reasoning stage provides a tentative analysis, which comprises diagnosis even if some information is missing or incorrect.

For instance, if some values important for a particular diagnosis are missing or if most values from measurements (except for, e.g., one single value) confirm a certain definition of a diagnosis, the diagnosis can be made and marked as “tentative”, also providing an explanation why this diagnosis is marked tentative.

Hereinafter, a first example illustrates the known CEP approach: A typical diagnostic model can be described as follows:

IF (Temp1>100) AND (Temp2<80) AND (Temp3>200) THEN Diagnosis1

Hence, if a first temperature Temp1 is larger than 100 and a second temperature Temp2 is below 80 and a third temperature Temp3 is larger than 200, a first diagnosis is true.

An automated analysis is confronted with a first situation, wherein the first to third temperature measurements are as follows:

Temp1=110;

Temp2=65;

Temp3=250.

Hence, all conditions are met, which results in providing said Diagnosis1.

As an alternative, the automated analysis is confronted with a second situation, wherein the first to third temperature measurements are as follows:

Temp1=110;

Temp2=65;

Temp3=195.

As a result, said Diagnosis1 is not true (i.e. does not apply) although two out of three measurements fall within the conditions defined for said diagnosis.

A second example illustrates the CEP approach in combination with OWA. The diagnostic model corresponding to the first example above can be defined as:

IF (Temp1>100) THEN Symptom1;

IF (Temp2 <80) THEN Symptom2;

IF (Temp3>200) THEN Symptom3.

A description logic for fault isolation can be determined as follows:

Diagnosis1 is Subclass of (Symptom1 AND Symptom2 AND Symptom3).

The automated analysis confronted with the first situation (measurements according to the first example above), i.e.

Temp1=110;

Temp2=65;

Temp3=250

results in determining said Diagnosis1 with certainty (all conditions are met, i.e. all symptoms Symptom1 to Symptom3 are true).

The automated analysis confronted with the second situation (measurements according to the first example above), i.e.

Temp1=110;

Temp2=65;

Temp3=195

results in a hypothetical Diagnosis1, because the third temperature Temp3 amounts to 195, which is not larger than 200 according to the condition defining Symptom3.

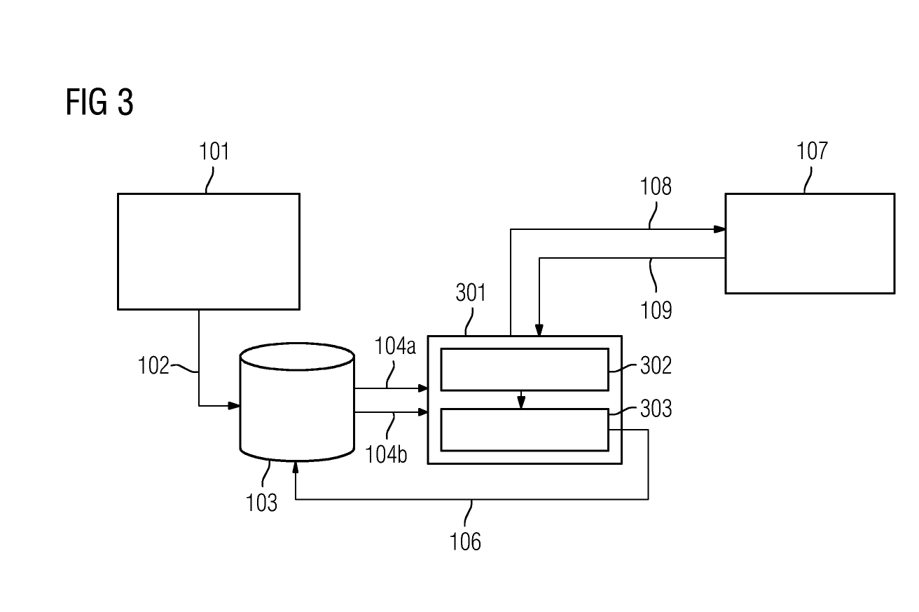

FIG. 3 shows an exemplary diagram visualizing the approach of using the (model-based) CEP approach in combination with the OWA for gas turbine diagnosis purposes. FIG. 3 is based on FIG. 1, except for the component 301, which provides an automated diagnosis also based on incomplete and/or uncertain information. The component 301 comprises a (model-based) CEP component 302 (which can correspond to the component 105 shown in FIG. 1) and a component 303 that uses the output of component 302 for deductive reasoning purposes on description logics for, e.g., fault isolation and/or failure determination purposes. The component 303 provides the results of the diagnosis and/or failure information supplied to the data base 103 and/or the device 107 for, e.g., further evaluation and/or processing.

Further advantages and embodiments:

A utilization of the model-based CEP approach as core engine for any diagnostic platform bears the following advantages:

(1) Complex information sources: A data and information environment of the rotating equipment, e.g., a gas or a steam turbine, is rather heterogeneous:
sensor signals are provided as measurements via numerical data,
technical messages from control units are provided as nominal data,
events are obtained or provided from condition monitoring systems,
a vibration analysis may be described as complex mathematical functions,
on-site visits produce manually written reports.

The model-based CEP allows native integration for complex information sources and/or non-trivial data types.

(2) Diagnostic models: A formalization of diagnostic knowledge as declarative models for further reuse is efficiently enabled by the model-based CEP approach presented herein. This reduces costs and time efforts otherwise required for adjusting existing non-flexible models. The approach is further highly scalable.

(3) Administration of diagnostic models: Typical prior art diagnostic models of faults and failures of the rotation equipment are rather complex and huge (i.e. un-scalable), often including the information sources. This model-based CEP solution enables an easy and user-friendly administration of diagnostic models.

(4) Lifecycle of diagnostic models: A prior art diagnostic model comprising potential faults and failures is yet hard-coded. Hence, such diagnostic model cannot be controlled, adapted or even modified during a diagnostic decision process. This disadvantage is efficiently overcome by the model-based CEP suggested herein: Diagnostic models can be easily modified even by personnel not being coders and/or by a process (i.e. in an automated way) during diagnosis.

(5) Modeling of time and temporal relations: The model-based CEP allows for native modeling of time constraints within the diagnostic models.

(6) Data streams: Preferably, diagnostic analysis may at least partially be conducted by processing parallel streams of information and data.

(7) Predictive diagnosis: In order to provide automated predictive analysis, various modules for data analysis are to be implemented, either as core engines or as services using data sources (e.g. data bases). The model-based CEP in particular supports the ability to provide predictive event patterns with limitation for only static probabilistic relationship.

It is also an advantage of the hybrid solution presented herein that large volumes of incomplete and/or uncertain information can be processed without or with limited risk of receiving false results. Hence, missing sensor information, wrong measurements and/or incorrect diagnostic models can be automatically identified and tentative analysis results can be provided to a user of the diagnosis.

Although the invention is described in detail by the embodiments above, it is noted that the invention is not at all limited to such embodiments. In particular, alternatives can be derived by a person skilled in the art from the exemplary embodiments and the illustrations without exceeding the scope of this invention.

1. A method for processing a technical system, comprising determining a prediction of the technical system based on a model-based complex event processing approach using declarative models.

2. The method according to claim 1, wherein the technical system comprises a rotating equipment and/or a generator.

3. The method according to claim 1, wherein based on said prediction, a diagnosis of the technical system or a portion thereof is determined.

4. The method according to claim 1, wherein based on said prediction a predetermined action is conducted.

5. The method according to claim 1, wherein the model-based complex event processing approach is based on an open world assumption.

6. The method according to claim 5, wherein the open world assumption is realized via deductive reasoning on description logics.

7. The method according to claim 6, wherein based on the deductive reasoning on description logics, a tentative prediction or diagnosis is provided based on incomplete, missing or wrong input data.

8. The method according to claim 7, wherein an explanation for the tentative prediction or diagnosis is generated.

9. The method according to claim 1, wherein the model-based complex event processing approach comprises definitions of events, complex events and a correlation mechanism for information sources.

10. The method according to claim 1, wherein the model-based complex event processing approach comprises processing data streams in parallel.

11. The method according to claim 1, wherein the model-based complex event processing approach is utilized by an optimization algorithm.

12. The method according to claim 1, wherein the model-based complex event processing approach comprises temporal reasoning.

13. The method according to claim 1, wherein the model-based complex event processing approach comprises induction or abduction mechanisms.

14. A device for processing a technical system comprising
a processing unit that is arranged for
determining a prediction of the technical system based on a model-based complex event processing approach using declarative models.

15. The device of claim 14, wherein the technical system comprises a rotating device or a generator.

16. The device of claim 14, wherein the technical system comprises a gas turbine.
